(19) United States
(12) Patent Application Publication
(10) Pub. No.: US 2026/0210002 A1
(43) Pub. Date: Jul. 23, 2026

(54) DEVICE FOR TWISTING ROVING THREADS INTENDED FOR THE PERIODIC PROFILE OF FRP COMPOSITE REINFORCEMENT

(71) Applicant: LIMITED LIABILITY COMPANY COMPOSITE GROUP CHELYABINSK, Chelyabinsk (RU)

(72) Inventor: Ramanathan NEELAKANDAN KRISHNA, Chennai (IN)

(21) Appl. No.: 19/143,397

(22) PCT Filed: Dec. 27, 2023
(86) PCT No.: PCT/IN2023/051232

§ 371 Date: Jun. 26, 2025

(30) Foreign Application Priority Data
Dec. 27, 2022 (IN) 202241075924

(51) Int. Cl. D01H 7/24

(52) U.S. Cl. CPC D01H 7/24; D10B 2505/02

(57) ABSTRACT

The invention relates to the field of construction, namely to equipment for the production of FRP composite rebar containing a spiral winding, which is used for reinforcing concrete structures and products. A device for twisting roving threads, including a frame, flywheels, a rod system, a thread layout on a smooth shaft, clamshell rods, a folding beam, removable spools mounted on drive axles, drives. At the same time, in the lower part of the frame, under the action of the drive, flywheels rotate around their axis with roving reels of the standard format (260 mm high; 185 mm in diameter; weighing 9-15 kg). From each reel, the threads are rewound through the rod system and the folding beam to rotating removable spools fixed on the drive axles. Thus, the quality of the produced FRP composite rebar increases, namely, the tensile strength of adhesion to concrete increases, due to the application of a periodic profile from roving threads that have passed the process of preliminary axial twisting.

The invention relates to the field of construction, namely to equipment for the production of FRP composite rebar containing a spiral winding, which is used for reinforcing concrete structures and products.

The technical result of the claimed invention is to improve the quality of the manufactured FRP composite rebar, namely, to increase the ultimate strength of adhesion to concrete, by applying a periodic profile of roving threads that have undergone the process of preliminary axial twisting.

The technical result is achieved by the fact that in a device for twisting roving threads, including a frame, flywheels, a system of rods, a folding thread on a smooth shaft, a folding rod, a folding beam, removable spools mounted on drive axles, drives, according to the invention, in the lower part of the frame, flywheels with fixed on their axes rotate around their axis under the action of the drive they are equipped with standard format roving bobbins (260 mm high; 185 mm in diameter; weighing 9-15 kg). From each bobbin, the threads are rewound through a system of rods and a folding beam onto rotating removable spools fixed on the drive axles.

Bobbins, spools rotating around their axis, a system of rods, a folding beam make it possible to ensure the roundness of the cross-sectional shape of the roving threads intended for applying FRP composite reinforcement to the trunk as a periodic profile, as well as to twist the roving threads directly during its rewinding on the spools. Thus, during the production of FRP composite reinforcement, threads that have undergone the process of preliminary axial twisting will be applied to the binder-impregnated bundle of threads of the bearing rod as a periodic profile along the radial surface, which provides the FRP composite reinforcement with increased adhesion strength to concrete.

By changing the rotation speed of the flywheels with bobbins, you can adjust the degree of twisting of the roving. So, the higher the rotation speed, the stronger the axial twisting of the threads and vice versa.

In the particular case of the thread twisting method, the degree of thread twisting is regulated by the rotation frequency of the roving bobbin platform in the roving thread twisting device, and various automation elements can be used to minimize deviation from the specified rotation speeds of the platform drive.

The formation of a periodic profile from twisted strands of fiberglass and/or basalt fiber, and/or carbon fiber, and/or aramid fiber, and/or their combination with pre-tension increases the characteristics of the rebar for tearing out of concrete, improves adhesion with concrete, which increases its strength and performance characteristics.

The essence of the declared utility model is explained by the figure:

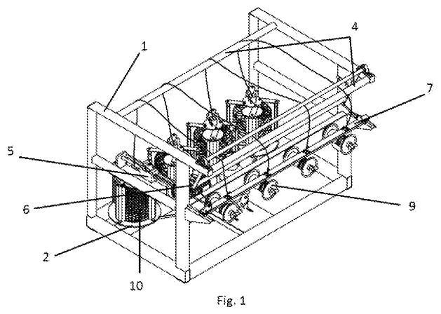

In FIG. 1 shows the general view of the device for twisting roving threads.

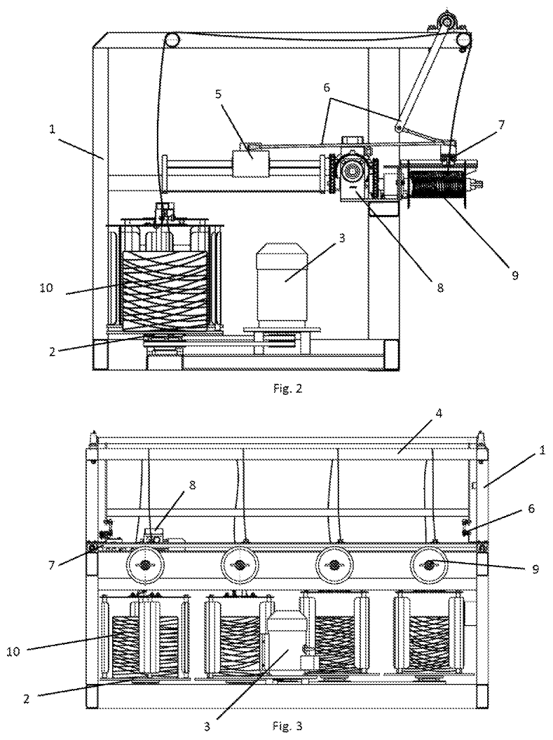

In FIG. 2 shows a left view of a device for twisting roving threads in section.

In FIG. 3 shows the front view of a device for twisting roving threads.

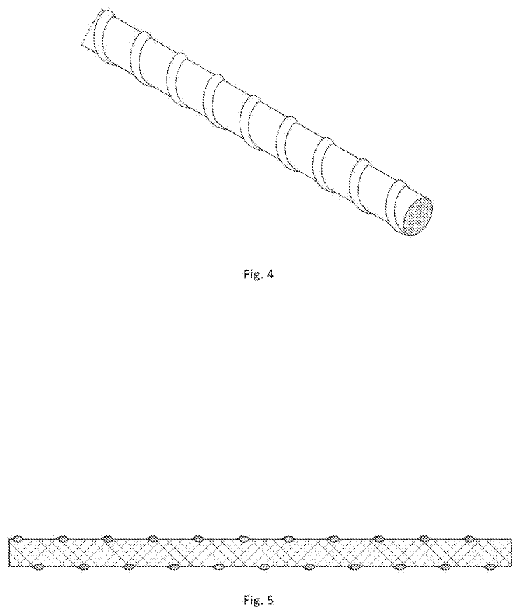

In FIG. 4 shows a general view of a FRP composite reinforcement with a periodic twisted roving profile.

In FIG. 5 shows a longitudinal section of a twisted roving FRP composite rebar rod.

The device for twisting roving threads comprises a frame 1, four flywheels 2 having a common drive 3, a rod system 4, axles having their own drive 8 with removable spools rigidly fixed to them 9, a folding beam 7, a thread layout on a smooth shaft 5, Powered by drive 8 rotation spool, thrust 6 thread spreader.

On the flywheels 2, with the help of brackets, bobbins 10 with roving are rigidly fixed. The threads from the bobbins rotating on the flywheels 2 reels 10 through the system of rods 4 and the folding beam 7 are rewound to the rotating spools 9. To the drive 8 of the spools, on the other hand, a folding 5 threads on a smooth shaft is attached, which, through the rods 6, transmits reciprocating motion to the folding beam 7 mounted on the guides, due to which the winding and distribution of twisted the threads along the spool 9 are fully synchronized, and the process of twisting and rewinding the threads costs without human participation.

Next, the spools with twisted roving threads are removed from the axes and are ready to be installed in the periodic profile formation unit in the FRP composite rebar production line.

Applying twisted roving to the barrel is carried out in different densities depending on the diameter of the rebar, which makes it possible to manufacture products for various consumer needs. So, the more densely the periodic profile is wound on the surface of the product (with one or more spools), the higher the characteristics of adhesion to concrete and the maximum strength for tearing out of concrete, which is a key advantage for laying reinforcement in columns, bridge supports, bridge pylons and other elements. This is achieved through the operation of the periodic profile, which has a rounded shape by twisting the thread, which sufficiently protrudes beyond the profile of the power rod and takes on part of the pulling load, thus much greater effort is required to separate the periodic profile from the power rod, and therefore the adhesion characteristics to the concrete are improved. The main results of tests for strength and adhesion to concrete of the resulting products are presented in the Table.

We claim:

1. A device for twisting roving threads designed for the periodic profile of FRP composite rebar, including a frame, flywheels, electric drives, a thread layout on a smooth shaft, removable spools fixed to the axles, thread spreader rods, a folding beam installed above the spools, characterized by the fact that the thread twisting occurs due to the rotation of the roving reels simultaneously with the coil and the layout twisted thread on spools used for installation in the periodic profile formation unit of the FRP composite rebar line.
